(19) United States
(12) Patent Application Publication
(10) Pub. No.: US 2011/0113977 A1
(43) Pub. Date: May 19, 2011

(54) Emulsion Ink

(75) Inventor: John Hamilton, Stirling (GB)

(73) Assignee: GR ADVANCED MATERIALS LTD., Stirling (GB)

(21) Appl. No.: 12/946,261

(22) Filed: Nov. 15, 2010

(30) Foreign Application Priority Data
Nov. 17, 2009 (GB) 0920145.0

(51) Int. Cl. B41M 1/12; C09D 11/10

(52) U.S. Cl. 101/129; 106/31.26; 347/100

(57) ABSTRACT

The present invention is directed to a water-in-oil (w/o) emulsion ink comprising an oil phase and an aqueous phase. The oil phase comprises a liquid resin having a viscosity in the range of from about 1000 to about 10000 centipoise (cP) in an amount of about 0.1 to about 10 weight % as based upon the total mass of the ink. The aqueous phase comprises pigment. When the pigment comprises carbon black, all of the carbon black pigment contained within the ink has a pH of at least about 5. The invention is also directed to a process for the preparation of a w/o emulsion ink, which comprises adding an aqueous phase to an oil phase. The oil phase comprises a resin which, during manufacture of the ink, is added to the oil phase as a liquid having a viscosity in the range of from about 1000 to about 10000 cP, and the ink comprises pigment which, during manufacture of the ink, is added to the aqueous phase. When the pigment comprises carbon black, all of the carbon black pigment has a pH of at least about 5. The inks find particular use in stencil printing, and in particular in digital duplication.

### FIELD OF THE INVENTION

The present invention relates to water-in-oil (w/o) emulsion inks for use in stencil printing processes and, in particular, digital duplication processes. More specifically, the present invention relates to such inks having improved image transfer and retention properties.

### BACKGROUND TO THE INVENTION

Ink transfer and retention properties and, in particular, ink fixing properties are important for stencil duplicating inks. Smudging of prints can occur when ink fixing is poor on feeding of a previously printed sheet of paper back through the printer. For instance, when a second colour is printed, a printed copy is fed back through the printer and the printer feed wheels can cause smudging of the initially-printed colour. Likewise, if the second side of an already-printed copy is required to be printed, the printed copy is fed back through the printer, which can also lead to smudging of the ink.

Another problem commonly encountered with stencil printed copies is rub off. Rub off resistance of printed copies is particularly important in educational establishments such as schools, colleges and universities, where lead pencils and erasers are commonly used to annotate texts. When an eraser is used upon stencil-printed matter, the top surface of the printed image is often removed. Accordingly, it is desirable that such printed matter resists removal of the image by the use of an eraser.

EP-A-0995779 describes a w/o emulsion ink, which comprises a resinous component having a free carboxylic acid group, or a higher fatty acid, in its oil phase. The aim of the work described in this publication is to maintain the viscosity of stencil inks and, thus, their stability over time. This is achieved via the formation of a metal soap across the w/o interface, which is formed by stepwise reaction of the resinous component or higher fatty acid with a mono-valent metal salt and then a dior tri-valent metal salt, each of which are present in the aqueous phase of the ink. GB-A-2408049 describes a w/o emulsion ink, for use in stencil printing and in particular digital duplication processes, which comprises a resin and pigment in its aqueous phase. Its aim is to try to optimise the image recovery performance of the ink, ie. the process of regaining full copy quality when a printer has not been used for some time. The inks described in this publication facilitate easier control of their rheologies and enable the preparation of differently coloured inks, which nevertheless display broadly similar and consistent rheologies.

GB-A-2420562 describes a further refinement of the control of rheology and, thus, stability of stencil printing inks by using a blend of two different types of carbon black, specifically carbon black with a pH of less than 6, and carbon black with a pH of greater than 6. The inks described in this publication achieve effective control of their rheology over time and also display consistent electrostatic properties.

Thus, a further consideration when designing new emulsion inks for stencil printing is to maintain or preferably enhance the other properties of such inks, for instance their electrostatic properties. In more detail, w/o emulsion inks have non-conducting electrostatic properties and, as such, take the properties of the continuous oil phase. This property is particularly useful in stencil printer design to monitor ink levels inside the ink drum using capacitance measurements. It is, therefore, important that the electrostatic properties of the inks are consistent such that stable readings are provided over a range of shear, temperature and ink age conditions.

Accordingly, it would be desirable to provide emulsion inks for use in stencil printing and, in particular, digital duplication processes, which display improved image transfer and retention properties and, specifically, improved smudging and rub off properties whilst, at the same time, maintain or improve upon the electrostatic performance of existing inks.

Another desirable aim in this technological field is to provide inks, which are cost effective and economical, ideally not only in terms of their components but also in the way in which they are made. For instance, some of the components included in emulsion inks of the art, such as acid carbon pigments, are expensive and, thus, it would be desirable to minimise or avoid the use of this type of component altogether, without compromising the performance of the ink if at all possible.

In addition and as is a common aim in the majority of technological fields today, it would be desirable to provide environmentally friendlier inks than those currently available. This may be achieved, for instance, by minimising the amount of environmentally less friendly components in inks or, ideally, avoiding their use altogether.

### SUMMARY OF THE INVENTION

According to a first aspect of the present invention, a water-in-oil (w/o) emulsion ink comprising an oil phase and an aqueous phase is provided, wherein the oil phase comprises a liquid resin having a viscosity in the range of from about 1000 to about 10000 centipoise (cP) in an amount of about 0.1 to about 10 weight % as based upon the total mass of the ink, wherein the aqueous phase comprises pigment and wherein, when the pigment comprises carbon black, all of the carbon black pigment contained within the ink has a pH of at least about 5.

According to a second aspect of the present invention, a process for the preparation of a w/o emulsion ink is provided, which comprises adding an aqueous phase to an oil phase, wherein the oil phase comprises a resin which, during manufacture of the ink, is added to the oil phase as a liquid having a viscosity in the range of from about 1000 to about 10000 cP, and wherein the ink comprises pigment which, during manufacture of the ink, is added to the aqueous phase. When the pigment comprises carbon black, all of the carbon black pigment has a pH of at least about 5.

A third aspect of the present invention provides a process for the preparation of a w/o emulsion ink, which comprises adding an aqueous phase to an oil phase, wherein the aqueous phase and the oil phase are as defined above.

Further aspects of the invention provide inks obtainable by the above-mentioned processes, uses of such inks in stencil printing processes and, in particular digital duplication processes, and stencil printing ink cartridges comprising such inks.

A yet further aspect of the present invention is directed to the use of a liquid resin as defined above to facilitate better rub-off properties of a stencil printing ink.

### DETAILED DESCRIPTION OF THE INVENTION

Inks according to the present invention are w/o emulsion inks, which comprise an aqueous or water phase dispersed within an oil phase.

Preferably, each of the aqueous and oil phases independently comprises about 10 to about 90 weight % of the total mass of the ink. More preferably, the aqueous phase comprises about 20 to about 85 weight %, and even more preferably about 50 to about 80% of the total mass of the ink. The oil phase more preferably comprises about 15 to about 80 weight %, and even more preferably about 20 to about 50 weight % of the total mass of the ink.

As is typical for emulsion inks, the aqueous phase of inks of the invention typically comprises water, usually together with one or more of the aqueous phase additives described below.

As is known in the art, the oil phase of the ink aids penetration of the ink into the paper to be printed. Because the surface of most commercially available paper is sized with a waterproofing agent to improve the wet strength of the paper, it has a tendency to repel water from the surface and absorb oil. This absorption process is an important aspect of the functioning of stencil printing inks, as absorption aids the drying process.

The oil phase of the ink of the invention may comprise any type of oil known and suitable for use in this type of ink. Typically, one or more hydrocarbon oils are used, such as commercially available mineral oils containing aromatic carbon atoms, naphthenic carbon atoms and/or paraffinic carbon atoms. Preferred types of oil suitable for use in the present invention are naphthenic and paraffinic oils, with naphthenic oils being particularly preferred.

Given the current push towards the inclusion of environmentally friendlier, sustainable components in inks in general, it is beneficial and preferable to include one or more oils derived from sustainable sources, such as vegetable oils, in the oil phase. Vegetable oils are typically mixtures of fatty acid glycerides and are usually mechanically extracted from seeds and beans. Examples of vegetable oils suitable for use in the present invention include soya bean oil, which itself mainly contains glycerides of palmitic, stearic, oleic and linoleic acids; rape seed oil, which contains mainly oleic, linoleic and erucic acids; and sunflower oil, which contains mainly palmitic, stearic, oleic and linoleic acids. Esterified vegetable oils and, in particular, methyl-esterified vegetable oils, are particularly preferred for use in the inks of the invention. The methyl esters of soya bean oil, rape seed oil and sunflower oil are most preferred.

If included, vegetable oils are typically present in the oil phase of inks of the invention in an amount of from about 5 to about 20 weight % and more preferably 6 to 10% as based upon the total mass of the ink.

The oil phase of emulsion inks typically and preferably has a viscosity in the range of from about 50 to about 160 centipoise (cP; as measured using a Brookfield viscometer at 19-21° C.), and more preferably in the range of about 110 to about 150 cP, in order to facilitate ease of processing of the ink and optimise its usage within stencil printing apparatus. In more detail, if the viscosity of the oil phase is too low, when the ink is printed on to paper this can lead to problems in terms of set off and drying of the printed ink, for instance. However, if the viscosity of the oil phase is too high, this can lead to uneven printing of the ink as not enough ink is delivered to the paper.

Thus, in order to achieve an oil phase with an appropriate viscosity, it may be desirable to use a mixture of different types of oils, in terms of their chemical and/or viscosity characteristics, for instance. For instance, it can be advantageous for the inks of the invention to contain a mixture of high (eg. 41-44 centiStokes, cSt, or mm²/s, measured at 40° C. using standard techniques for oils) and low (eg. 11-16 cSt or mm²/s, measured at 40° C.) viscosity oils within the oil phase. Even more preferably, a mixture of high and low viscosity naphthenic oils is employed. Mixing of oils to achieve an oil phase with the desired viscosity range would be readily achievable by a person skilled in the art using standard techniques.

At least one liquid resin with a viscosity in the range of from about 1000 to about 10000 centipoise (cP) as measured at room temperature (eg. 19-21° C.) on a Brookfield viscometer using techniques well known in the art, is comprised within the oil phase of the inks of the invention. More preferably the viscosity of the resin is in the range of from about 2000 to about 8000 cP, and even more preferably is in the range of from about 3000 to about 7000 cP. Yet even more preferably, the viscosity of the resin is in the range of from about 40000 to about 6000 cP. Most preferably, the viscosity of the resin is in the range of from about 4500 to 4900 cP, for instance about 4600 to about 4800 cP, and is yet most preferably about 4700 cP. Higher viscosity resin materials may be incorporated into the inks of the invention, if it is possible to reduce their viscosity to within the above-mentioned ranges by heating the bulk resin to aid blending into the oil phase, or by diluting the resin using appropriate hydrophobic solvents. With this in mind and given the above discussion in relation to the desired viscosity of the oil phase of the ink, it is key that the viscosity of the liquid resin included in the oil phase does not negatively affect the overall viscosity of the oil phase. For instance, if the resin is highly viscous, ie. its viscosity is greater than 10000 cP, there is a risk of stencil blocking and processing difficulties when making the w/o emulsion inks of the invention.

It has been found that the inclusion of this type of liquid resin within the oil phase of inks of the invention leads to better rub off properties of the printed inks. In more detail and whilst not intended to be bound by theory, it is thought that the resins may have a dual role in that they may also act as binders for the pigment particles contained within the inks of the invention. Thus, on drying of the printed ink on the paper, it is thought that the resins may hold the pigment particles more effectively upon the paper and, therefore, reduce rub off of the printed ink during use of the printed matter.

In addition, it has been found that the inclusion of this type of liquid resin facilitates greater control of drying of the ink. In stencil printing inks, control of ink drying is key as, as is well known in this field, if drying of the ink occurs too quickly, stencil blocking will occur, whereas if drying occurs too slowly, problems such as ink transfer from the final printed copies can occur.

Resins suitable for use in the present invention are termed “liquid” resins which, in the context of the present invention, means that the resins are typically in liquid form at temperatures at which stencil printing equipment is operated, eg. at room temperatures of around 10-30° C., for instance. It is also preferred that the resin be compatible, ie. substantially miscible with the oil phase and, more preferably, with naphthenic oils. Miscibility can be assessed visually, such that the blend should be transparent or translucent and should not show separation into two layers.

Preferred resins suitable for use in the present invention include polystyrene derivatives such as that commercially available from Eastman Chemical Company under the tradename Piccolastic A5; branched polyalcohols such as those with ester and/or ether groups, for instance those commercially available from Bayer MaterialScience under the tradenames Desmophen 1140 and 1155; polyester derivatives such as polyester polyols, for instance that commercially available from Bayer MaterialScience under the tradename Desmophen 850; and polyether derivatives such as polyether polyols, for instance those commercially available from Bayer MaterialScience under the tradenames 1990U and 1915U; and mixtures thereof.

More preferably, the oil phase of the ink comprises as least one polyester- or polystyrene-derived resin. Even more preferred resins suitable for use in the invention are alkyd polyester derivatives. Such alkyd resins are particularly preferred because they are low cost and are versatile in performance in terms of drying rate, adhesion and compatibility with the other ink components. Alkyd resins are typically classed as “drying” or “non-drying”, which terms take their normal meaning in the art and are described below.

Most preferably, the resin is a soya oil-modified alkyd resin. A particularly preferred resin is a soy resin, which is comprised of greater than 99 weight% soy alkyd resin, and less than 1 weight% of each of xylene and n-butanol and which has a viscosity of about 4700 cP, as measured at 19-21° C. using a Brookfield viscometer. Soya oil-modified resins are particularly preferred as soya oil is classed as a so-called “semi-drying” oil which, as in understood in the art, means an oil which partially hardens upon exposure to air under ambient conditions. This may be compared with a “drying” oil, which hardens completely, or a non-drying oil, which does not harden at all upon exposure to air. An alternative way in which these terms may be understood is with reference to the iodine numbers of the oils. Oils with iodine numbers in the range of from about 110 to about 130 are considered as semi-drying oils, and soya oil derivatives generally have iodine numbers of from about 110 to about 125, with derivatives having iodine numbers of about 115 to about 125 being particularly preferred for use in the present invention.

Accordingly, the use of soya oil to modify the properties of the resin achieves enhanced fixing properties of the resulting ink, without leading to excessive drying which would otherwise lead to blockages within the stencil printer.

The liquid resin is present in the oil phase in an amount of about 0.1 to about 10 weight % and preferably about 0.2 to about 8 weight %, as based upon the total mass of the ink. More preferably, the resin comprises about 0.3 to about 6 weight %, even more preferably about 0.4 to about 3 wt %, and most preferably about 0.5 to about 1 weight % of the total mass of the ink. It is clearly beneficial that the liquid resin may be included in the oil phase of the ink in such relatively low amounts in order to keep the overall costs of the ink to a minimum and yet, at the same time, still achieve the clear benefits of the inventive inks in particular in terms of rub off and drying, as described above.

As is typical for emulsion inks, the oil phase of the inks of the invention also usually comprises an emulsifier, which may be any material capable of forming a w/o emulsion in conjunction with the chosen oils and aqueous phase. Thus, any emulsifier commonly used in this type of w/o ink is suitable for use in the present invention. Without wishing to be bound by theory, it is understood that the emulsifier typically concentrates at the interface between the oil and aqueous phases which, as is understood in the art, typically means that the aqueous phase, ie. water droplets, are coated with a very thin layer of emulsifier. Suitable emulsifier materials include but are not restricted to sorbitan esters such as sorbitan mono-oleate and sorbitan sesquioleate, and lipids such as soya lecithin and polymeric emulsifying agents commonly used in this field. The emulsifying agent may be a single emulsifying agent or a blend of different emulsifying agents, with sorbitan mono-oleate being preferred.

The emulsifier may typically be included in the inks of the invention in an amount of about 0.1 to about 10 weight %, preferably about 1 about 8 weight % and more preferably about 2 to about 7 weight % of the total mass of the ink.

Emulsion inks typically contain colorants or pigments and, as is well known in the art, pigments are typically coloured powders that are either organic or inorganic in nature and which are used to colour substrates. When properly dispersed in liquid ink formulations, pigments impart brilliant colour hue, opacity and resistance properties to prints. In the context of the present invention, the terms “colorant” and “pigment” are used interchangeably.

The inks of the invention comprise pigment, which is added to the aqueous phase during manufacture of the ink. When the pigment comprises carbon black, all of the carbon black has a pH of greater than or equal to about 5, and preferably has a pH of equal to or greater than about 6. In other words, the inks of the invention do not contain any “acid carbon”. This term is well understood in the art. It is advantageous in terms of cost that the ink contains no acid carbon as, due to the nature of its manufacture, which typically includes surface treatment, acid carbon is a relatively expensive component, the use of which it is therefore desirable to avoid. It is preferred that the pigment comprised within the inks of the invention itself comprises or, preferably, consists essentially of or, most preferably, consists of carbon black as described above, ie. that having a pH of at least about 5. However, as described below, the inks may contain one or more pigments other than carbon black, as an alternative thereto or in combination therewith.

In the context of the present invention, the pH of the carbon black pigment may be determined in accordance with the standard test method ASTM D 1512, in which the acidity of the carbon black is measured after extraction thereof into water. More preferably the carbon black in the inks of the invention has a pH of from about 5 to about 10, and even more preferably from about 6 to about 8.

If incorporated into the inks of the invention, the carbon black pigment may be selected from any type of carbon black commonly available and typically used in inks, as long as the pH requirement is met. Also, such carbon black pigments may be used alone or as mixtures in the present invention.

If present, typically the carbon black pigment in the inks of the invention has a particle size as measured by laser diffraction of less than about 10 μm, preferably less than about 5 μm, more preferably less than about 2 μm, and most preferably less than about 1 μm.

Typically, the total carbon black pigment concentration in the inks of the invention will fall within the range of from about 1 to about 20 wt %, preferably from about 2 to about 15 wt %, and more preferably from about 3 to about 9 wt %, as based upon the total mass of the ink.

As an alternative or in addition to the above-described carbon black, the aqueous phase of the inks of the invention may comprise one or more inorganic or organic colorants or pigments selected from those typically used in emulsion inks. For instance, useful organic pigments include phthalocyanine, quinacridone, diarylide, lithol salt, carbazole, metal complex pigments and indanthrene compounds, amongst many other well known possibilities.

Useful inorganic pigments include calcium carbonate, magnesium silicate and titanium dioxide, again amongst many other well known possibilities.

The total amount of pigment included in the inks of the invention, including the carbon black pigment it present, is typically in the range of from about 1 to about 20 weight %, preferably from about 2 to about 15 weight %, and more preferably from about 3 to about 9 weight %, as based upon the total mass of the ink.

As is typical for w/o emulsion inks, the inks of the invention may comprise one or more water-soluble resins, which facilitate dispersion of the pigment in the aqueous phase. When a water-soluble resin is used in the ink it is particularly preferred that the water phase should be substantially free, and most preferably entirely free, of any surfactant. In this regard, it is noted that the use of emulsion resins should generally be avoided since they frequently contain surfactants. In the context of the present invention, by “substantially free” is meant that any surfactant is only present in such a small amount so as not to adversely affect the ink capacitance properties and, therefore, the ink detection properties, and so as not to function as a dispersant for the pigment in the water phase.

Suitable water-soluble resins for use in the present invention include but are not restricted to polymers, copolymers or more complex polymeric permutations of vinyl alcohol, ethylene oxide, vinyl pyrrolidone, vinyl methyl ether and acrylamide. Polymers derived from the aforementioned monomers in conjunction with other monomers such as styrene, vinyl acetate and acrylic acid esters in such proportions that they confer water solubility are also suitable. Polymers and copolymers of N-vinyl pyrrolidone are preferred.

If included, the water-soluble resin may be present in the inks of the invention in an amount of from about 0.5 to about 30 weight %, and preferably from about 1 to about 10 weight% as based upon the total mass if the ink.

Advantageously, it has been found that the presence of the water-soluble resin positively affects the smudging performance of the inks of the invention, and this is thought to be due to the resins binding the pigment particles of the dried ink film to the paper fibres and to other particles in the dried film.

The aqueous phase may additionally comprise one or more further conventional ink components, such as antifreeze agents or humectants, dispersants, stabilisers and biocides.

For instance, antifreeze agents or humectants may be added to prevent the ink becoming unstable after freezing and thawing. They also act as retardants to “slow” drying. This leads to a compromise as, whilst it is obviously desirable for the ink to be dry once printed, in the stencil printing process if the ink dries on the stencil, the printed image will be blurred because the open areas of the stencil become blocked with dried ink.

The antifreeze agent or humectant may be selected from a wide range of suitable compounds typically used in emulsion inks. Water soluble alcohols or polyols are preferred, with ethylene glycol, sorbitol, polyethylene glycol, glycerol and mixtures thereof being particularly preferred. More preferably, polyols having a boiling point of greater than 197° C. (as measured by standard methods of the art) are used, with glycerol being the most preferred type of this component for use in the present invention.

If included, the antifreeze agent or humectant may be present in the inks of the invention in an amount of from about 2 to about 30 weight %, preferably from about 3 to about 20 weight %, and even more preferably from about 4 to about 12 weight % as based upon the total mass of the ink.

In addition to the water-soluble resins described above, dispersants may be added to aid dispersion of the pigment powder. The dispersant can also help to reduce the particle size of the pigment powder. Small particles, eg. of particle size less than about 1 μm, are desirable in order to give good hiding properties on the print, ie. good print density. In stencil printing, it is also desirable that the pigment particle size is small to reduce the risk of the stencil open area becoming blocked. Dispersants also aid keeping the pigment particles in dispersion over a long time period. If the dispersion is unstable the particles may flocculate into particle conglomerates, with such flocculation potentially resulting in poor hiding properties and also ink instability.

Examples of suitable dispersants include the water soluble resins described above as well as acetylenic diol derivatives, amongst other possibilities well known in the art. Blends of dispersant may also be used. If included, the dispersant may be present in the inks of the invention in an amount of from about 0.5 to about 30 weight % and preferably from about 1 to about 10 weight % as based upon the total mass if the ink.

Stabilisers such as inorganic salts, eg magnesium sulphate, and organic gellants such as acrylate copolymers may be added to the ink in order to improve the long-term storage stability of the ink, so that after 1 or 2 years the ink can be used without any issues arising during its use. If included, stabilisers may be present in the inks of the invention in an amount of from about 0.01 to about 10 weight % and preferably from about 0.02 to about 8 weight % as based upon the total mass if the ink.

Biocides may be added to prevent the ink becoming spoiled with bacteria, yeasts or moulds. They function both “in can”, ie. in the storage container, and in the “wet state”, ie. during use of the ink on printers where thin films of ink will be exposed to the atmosphere. Typical active components are benzalkonium chloride, bronopol, formaldehyde donor materials and isothiazolinone derivatives. Most preferred are benzisothiazolinone, methyl isothiazolinone and octyl isothiazolinone. If included, biocides may be present in the inks of the invention in an amount of from about 0.1 to about 5 weight % and preferably from about 0.2 to about 2 weight % as based upon the total mass if the ink.

The inks of the invention may also contain other standard ink components well known in this field such as fillers, antioxidants, pH adjusting agents, stabilisers and water phase and oil phase gels.

As described above, the inks of the invention may be made by a process, which comprises adding an aqueous phase to an oil phase. The aqueous phase and the oil phase may be as previously described.

The present invention is also directed to a process for the preparation of a w/o emulsion ink, which comprises adding an aqueous phase to an oil phase, in which the oil phase comprises a resin which, during manufacture of the ink, is added to the oil phase as a liquid having a viscosity in the range of from about 1000 to about 10000 cP. The preferred types of liquid which provide the resin suitable for use in this process are as described above. The ink made by this process comprises pigment which, during manufacture of the ink, is added to the aqueous phase. When the pigment comprises carbon black, the carbon black consists of carbon black having a pH of at least about 5. In other words and as described above, the carbon black used in this process and which is, therefore, contained within the resulting ink does not contain any “acid carbon”.

The present invention will now be described with reference to the following examples.

### EXAMPLES

Inks according to the present invention (Examples 4 and 5) and inks made for comparative purposes (Examples 1-3) were made by a process described as follows, in three stages. The ink components and test results are summarised in Table 1. All component amounts are given as parts by weight (pbw) unless otherwise stated.

Stage 1: Base Preparation

Water, dispersant, resin and biocide were premixed and then pigment powder was added and stirred on a high-speed stirrer. The premix was then recirculated through a horizontal bead mill until a small particle size was achieved.

Stage 2: Water Phase Preparation

The base from Stage 1 was then mixed with further water, antifreeze and other components, if added, to the water phase and stirred on a low speed stirrer until the mix was homogeneous.

Stage 3: Ink Emulsification

The oil phase components (eg. mineral oils, emulsifiers, resins and other oil phase components) were firstly premixed. The water phase from Stage 2 was then added to the stirring oil phase, at a controlled rate, ensuring that a w/o emulsion was formed. When the water phase addition was complete, the ink was stirred at high speed to give a w/o emulsion containing small water drops dispersed in the oil phase.

TABLE 1

| Comparative | Comparative | Comparative | Example | Example |
|---|---|---|---|---|
| Example 1 | Example 2 | Example 3 | 4 | 5 |

Base Formulation

| | | | | | |
|---|---|---|---|---|---|
| Water | 10.91 | 7.92 | 9.04 | 9.34 | 9.49 |
| Acetylenic diol derivative | 1.67 | | | | |
| 30% aqueous solution of vinyl | 6.11 | 12.17 | | | |
| pyrrolidone polymer | | | | | |
| Vinyl pyrrolidone polymer solid | | | 1.10 | 0.95 | 1.00 |
| Mixed isothiazolinone biocide | | | 0.30 | 0.34 | 0.32 |
| Furnace carbon black | 7.31 | 7.31 | 4.16 | 3.98 | 3.79 |

Water Phase Formulation

| | | | | | |
|---|---|---|---|---|---|
| Base | 26.00 | 27.40 | 14.6 | 14.60 | 14.60 |
| Water | 39.30 | 40.29 | 56.1 | 56.10 | 57.10 |
| Acrylate copolymer | 0.18 | | | | |
| Ammonia ^{a} | 0.02 | | | | |
| Mixed isothiazolinine biocide | 0.30 | 0.30 | | | |
| Glycerol | 7.00 | 7.00 | 5.00 | 5.00 | 5.00 |
| 30% aqueous solution of vinyl | 5.20 | | | | |
| pyrrolidone polymer | | | | | |
| 17% aqueous magnesium | | | 0.30 | 0.30 | 0.30 |
| sulphate solution | | | | | |
| Sodium hydroxide ^{b} | | 0.01 | | | |

Ink Formulation

| | | | | | |
|---|---|---|---|---|---|
| Soy resin ^{c} | | | | 0.75 | 0.75 |
| High viscosity | 4.00 | 12.33 | 16.00 | 16.75 | 11.25 |
| naphthenic oil ^{d} | | | | | |
| Low viscosity | 14.00 | 6.87 | 5.00 | 4.00 | 7.00 |
| naphthenic oil ^{e} | | | | | |
| Sorbitan mono-oleate | 4.00 | 5.80 | 3.00 | 2.50 | 4.00 |
| Water phase | 78.00 | 75.00 | 76.00 | 76.00 | 77.00 |

Results

| | | | | | |
|---|---|---|---|---|---|
| Ink detection signal ^{f} | −40.0 | 0.8 | 2.4 | 0 | 0.8 |
| Rub off ^{g} | — | 70.97 | 65.8 | 63.6 | 73.9 |
| Smudging grade ^{h} | — | 4.17 | 4.38 | 4.50 | 4.38 |

Notes for Table 1 and Explanation of Test Results
^{a} ammonia used in the form of a 1.4-1.5 weight % aqueous solution
^{b} 0.01 pbw of solid sodium hydroxide, which is added as a 10 weight % aqueous solution.
^{c} soya oil modified alkyd resin, which is comprised of greater than 99 weight % soy alkyd resin, and less than 1 weight % of each of xylene and n-butanol and which has a viscosity of about 4700 cP, as measured at 19-21° C. using a Brookfield viscometer.
^{d} kinematic viscosity 41.5-43.4 mm²/s
^{e} kinematic viscosity 11.9-15.5 mm²/s
(each of ^{d} and ^{e} are as measured at a temperature of 40° C.)
^{f} The expected ink detection signal range is +/− 5 μs from the reference signal. When the signal is lower than the reference signal by more than 5 μs, the stencil printing system prompts ink to be pumped into the drum to prevent prints becoming light. When the ink detection signal is greater than the reference signal by more than 5 μs, the system prompts the pump to stop pumping ink to prevent the drum from flooding.
It can be seen from the results presented in Table 1, that the inks of the invention have limited ink detection signal variability and, thus, good electrostatic properties. This ensures that the reliability of the inks of this invention in printers is good with very low risk of the ink level becoming too low or too high.
^{g} Rub off is a measure of the percentage of the original print density remaining after being rubbed off in comparison with the original print density. At 60% rub off, the difference can be noticed by the naked eye, but the print is still easily legible. At less than 50% rub off, the legibility of the fine detail of the print is poor. In other words, a 100% rub off value means that no ink has been removed from the printed matter during testing. During testing, rub off was performed using a Crockmeter and the resulting rub off effect was measured using a Macbeth ™ densitometer, in accordance with standard techniques.
The rub off results presented in Table 1 show that the inks of the invention each display excellent rub off resistance.
^{h} Smudging grade numbers are a ranking system from 2 to 5, where 2 is poor and 5 is excellent. The standard level required for ink smudging performance is greater then 3.25.
The smudging results presented in Table 1 show that the inks of the invention each display excellent resistance to smudging.

1. A water-in-oil (w/o) emulsion ink comprising an oil phase and an aqueous phase, wherein the oil phase comprises a liquid resin having a viscosity in the range of from about 1000 to about 10000 centipoise (cP) in an amount of about 0.1 to about 10 weight % as based upon the total mass of the ink, wherein the aqueous phase comprises pigment and wherein, when the pigment comprises carbon black, all of the carbon black pigment contained within the ink has a pH of at least about 5.

2. An ink according to claim 1, wherein the viscosity of the resin is in the range of from about 2000 to about 8000 cP.

3. (canceled)

4. An ink according to claim 1, wherein the resin is a polyester- or polystyrene-derived resin.

5. An ink according to claim 4, wherein the resin is an alkyd resin.

6. An ink according to claim 5, wherein the alkyd resin is polyester resin modified with soya oil.

7. An ink according to claim 1, wherein the resin is present in an amount of about 0.2 to about 8 weight % as based upon the total mass of the ink.

8. An ink according to claim 1, wherein the pigment comprises carbon black, wherein all of the carbon black contained within the ink has a pH of at least about 5.

9. An ink according to claim 1, wherein the oil phase comprises a vegetable oil.

10. An ink according to claim 9, wherein the vegetable oil is an esterified vegetable oil.

11. A process for the preparation of a water-in-oil (w/o) emulsion ink, which comprises adding an aqueous phase to an oil phase, wherein the oil phase comprises a resin which, during manufacture of the ink, is added to the oil phase as a liquid having a viscosity in the range of from about 1000 to about 10000 cP, and wherein the ink comprises pigment which, during manufacture of the ink, is added to the aqueous phase and wherein, when the pigment comprises carbon black, all of the carbon black pigment has a pH of at least about 5.

12. A process according to claim 11, wherein the resin has a viscosity in the range of from about 2000 to about 8000 cP.

13. A process for the preparation of a water-in-oil (w/o) emulsion ink, which comprises adding an aqueous phase to an oil phase, wherein the aqueous phase and the oil phase are as defined in claim 1.

14. An ink obtainable by a process according to claim 11.

15-16. (canceled)

17. A stencil printing process comprising providing an ink as defined in claim 1 to a stencil printing apparatus.

18. A process according to claim 17, wherein the stencil printing apparatus is a digital duplicator.

19. A stencil printing ink cartridge comprising an ink as defined in claim 1.

20. (canceled)

21. A process according to claim 11, wherein the resin is a polyester- or polystyrene-derived resin.

22. A process according to claim 11, wherein the resin is an alkyd resin.

23. A process according to claim 22, wherein the alkyd resin is polyester resin modified with soya oil.

24. A process according to claim 11, wherein the resin is present in an amount of about 0.2 to about 8 weight % as based upon the total mass of the ink.
